(19) United States
(12) Patent Application Publication
(10) Pub. No.: US 2022/0272110 A1
(43) Pub. Date: Aug. 25, 2022

(54) SYSTEMS AND METHODS OF CREATING NETWORK SINGULARITIES AND DETECTING UNAUTHORIZED COMMUNICATIONS

(71) Applicant: Airgap Networks Inc., (US)

(72) Inventor: Ritesh R. Agrawal, San Jose, CA (US)

(21) Appl. No.: 17/461,694

(22) PCT Filed: Mar. 2, 2020
(86) PCT No.: PCT/US2020/020593

§ 371 Date: Aug. 30, 2021

Related U.S. Application Data
(60) Provisional application No. 62/813,160, filed on Mar. 4, 2019.
(60) Provisional application No. 62/897,373, filed on Sep. 8, 2019.

(51) Int. Cl. H04L 9/40

(52) U.S. Cl. CPC H04L 63/1416; H04L 63/0236; H04L 63/1425; H04L 63/20

(57) ABSTRACT

Systems and methods of creating a network singularity for a network connected device deployed over a shared network, analyzing the shared network traffic to detect unauthorized communication, and implementing security and access control for the network singularity. Systems and methods for creating network subnet for the network singularity, detecting unsolicited response to and from the network singularity, and discarding the unsolicited response to interrupt unauthorized communication.

### CROSS REFERENCE TO RELATED APPLICATIONS

This application claims priority under 35 U.S.C. § 119 to U.S. Provisional Patent Application No. 62/813,160, filed, Mar. 4, 2019, and titled SYSTEMS AND METHODS OF CREATING NETWORK SINGULARITIES and to U.S. Provisional Patent Application No, 62/897,373, filed, Sep. 8, 2019, and titled SYSTEMS AND METHODS OF CREATING NETWORK SINGULARITIES, each of which is hereby incorporated by reference herein in its entirety.

### TECHNICAL FIELD

Systems and methods consistent with the principles of the present disclosure relate generally to cyber security, and more particularly, the present disclosure relates to systems and methods of creating network singularities for network connected devices deployed over a shared network.

### BACKGROUND

Internet of Things (IoTs) may offer distinct advantages across multiple disciplines such as, but not limited to, entertainment systems, medical equipment, kiosks, electric charging stations, security and surveillance, collaboration systems, and building management. These IoTs may be network connected devices designed to perform designated tasks. Such IoTs and other network connected devices such as desktop computers, application servers, and laptops may represent cyber-security, data manipulation, and data theft risks when deployed over a shared network along with plurality of other network connected devices. Further, many of the network connected devices may not provide methods and procedures to install security agent software such as anti-virus agents for added protection. In addition, system anomalies or system vulnerabilities in one or more network connected devices may have the potential to impact the remainder of the network connected devices in a shared network deployment. Further, many of the network connected devices may not provide adequate protection against access to their default services such as web-servers. When deployed in a shared network topology, anyone with access to the same network may gain unauthorized access to such network connected device's services. Additionally, a vulnerable network connected device may be exploited by adversaries to use its resources for unlawful activities thereby impacting the reputation of the network owner. Further, in a shared network deployment, broadcast packets such as address resolution protocol (ARP) packets may be broadcasted affecting the performance of the connected devices as well as share broadcasting device's information. Additionally, in a shared network, it may be inefficient to apply network access policies for individual devices.

Accordingly, in order to reduce the associated risks and improve system efficiencies, it is desirable to employ systems and methods of creating network singularities for each of the network connected device. It is further desirable to detect unauthorized communication between network connected devices and generate appropriate system alerts when the presence unauthorized communication is detected. Additionally, it is desirable to have a mechanism to stop proliferation of unauthorized communication on the shared network. Further, it is desirable to have authentication and network access policy control for communication to and from the connection devices within each of the network singularities.

U.S. Pat. No. 9,210,192B1 entitled Setup of multiple IOT devices assigned to Belkin International Inc. describes a way to setup of multiple devices to a shared local area network. While the described techniques fail to provide protection against unauthorized communication between devices deployed over a shared network.

U.S. Pat. No. US20120284299A1 entitled Preventing leakage of information over a network by International Business Machines Corp. describes instructions for determining whether or not the information to be acquired by the original request is singular with respect to a request previously issued request as stored in a request log in which a history of search values is registered. Such techniques fail to provide protection against unauthorized communication between devices deployed over a shared network.

U.S. Pat. No. US20050246767A1 entitled Method and apparatus for network security based on device security status assigned to Avaya Inc. describes methods and apparatus for device's security update status to determine version level of one or more security features of the device. However, such techniques fail to provide protection against unauthorized communication between devices deployed over a shared network.

Conventional systems and methods do not provide adequate protection against unauthorized communication between network connected devices deployed over a shared network. In these respects, systems and methods of creating a network singularity for a network connected device deployed over a shared network and analyzing the network traffic for detecting unauthorized communication between network connected devices according to the present disclosure substantially departs from the conventional concepts and designs of the prior art, and in so doing provides methods and systems primarily developed for the said purpose.

### SUMMARY

In one aspect, the present disclosure provides systems and methods of creating a network singularity for a network connected device.

In another aspect, the present disclosure provides systems and methods of creating a network singularity for a network connected device deployed over a shared network and analyzing the network traffic for unauthorized communication.

In yet another aspect, the present disclosure provides systems and methods of creating a network singularity for a network connected device deployed over a shared network wherein the shared network may be a data link layer (L2) network or a network layer (L3) network or a combination thereof.

In yet another aspect, the present disclosure provides systems and methods of creating a network singularity for a network connected device deployed over a shared network, analyzing the network traffic to detect unauthorized communication, and providing a system alert indicating associated network singularity's involvement in unauthorized communication.

In yet another aspect, the present disclosure provides systems and methods of creating a network singularity for a network connected device deployed over a shared network, analyzing the shared network traffic to detect unauthorized communication, providing a system alert indicating unauthorized communication, and restricting network access for associated network singularity.

In yet another aspect, the present disclosure provides systems and methods of creating a network singularity for a network connected device deployed over a shared network and providing restricted network access to the associated network singularity.

In yet another aspect, the present disclosure provides systems and methods of creating a network singularity for a network connected device deployed over a shared network and the systems and methods comprising of one or multitude of default gateways and access control systems for the network singularity.

In yet another aspect, the present disclosure provides systems and methods of creating a network singularity for a network connected device deployed over a shared network and the systems and methods comprising of a security policy database comprising of network access control and security policies for the network singularity.

In yet another aspect, the present disclosure provides systems and methods of creating a network singularity for a network connected device deployed over a shared network and the systems and methods comprising of a security policy database providing application programming interface (API) for the network singularity's security policy updates.

In yet another aspect, the present disclosure provides systems and methods of creating a network singularity for a network connected device deployed over a shared network and the systems and methods comprising of interfaces and access to various functions necessary for the network connected device's expected operations.

In yet another aspect, the present disclosure provides systems and methods of creating a network singularity for a network connected device deployed over a shared network and the systems and methods comprising of an administrative portal to manage administrative functions further comprising of visualization of device traffic statistics, definition of network access control policies, definition of security policies, notification of system alerts, enumeration of network connected devices and the network singularities along with their respective attributes, definition of chaining additional network functions, and configuration of administrative settings such as account credentials, system settings, network preferences, alert preferences, and configuration settings for interfacing with external systems.

According to yet another aspect, the present disclosure relates to systems and methods of creating a network singularity for a network connected device deployed over a shared virtual local area network (VLAN). While a shared network such as VLAN allows for communication between the network connected devices, the proposed systems and the methods include assigning unique network subnets for the network connected devices and assigning a default gateways for each of the subnets. According to the exemplary aspect, each of the subnets comprises of four (4) Internet protocol (IP) addresses for the network connected device, broadcast traffic, the network singularity address, and a default gateway. Further, according to this exemplary aspect, such a subnet may be defined as network singularity. Additionally, since the network connected device may be the only network connected device within the network singularity, communication with applications or devices outside of the network singularity may be required to pass through the default gateway address of the network singularity. The default gateway may be responsible for forwarding traffic to other devices or applications. Further, a traffic inspection system may be deployed over the same VLAN to inspect broadcast traffic such as address resolution protocol (ARP) traffic. Since network singularity's communication may pass through the default gateway, attempts to bypass this method may be detected by the inspection system and the system may generate an unauthorized communication alert. Subsequently, the default gateway may restrict the network singularity from participating in further communication on the shared network. Further, according to this exemplary aspect, one or multitude of the default gateways may be hosted at a remote location and the communication between the network connected device and respective default gateway may be established over one or multitude of tunnel encapsulation protocol such as Virtual Extensible LAN (VXLAN) or L2 over Generic Routing Encapsulation (GRE) protocols.

According to yet another aspect, the present disclosure relates to systems and methods of creating a network singularity for multitude of network connected devices deployed over a shared VLAN wherein the network connected devices within the VLAN may have the authorization to communicate with each other without the need to pass through the default gateway of the network subnet. As per the exemplary aspect, such a subnet may be defined as network singularity. Communication with applications or devices outside of the network singularity may be required to pass through the default gateway. An unauthorized request to the network singularity may result in an unsolicited response towards the gateway for the associated network singularity. Further, the network singularity's gateway may be instructed to drop unsolicited responses thereby interrupting attempted unauthorized communication with the network singularity.

According to yet another aspect, the present disclosure relates to systems and methods of creating a network singularity for a network connected device deployed over a shared VLAN. The proposed systems and the methods include a centralized security policy database that may host security policy table for the network singularity. Traffic to and from the network singularity may be subjected to the associated security policy enforcement wherein the policies are derived from the database. Additionally, application programming interface (APIs) may be published for updating network singularity specific security policies.

According to yet another aspect, the present disclosure relates to systems and methods of creating a network singularity for a network connected device deployed over a shared VLAN. The proposed systems and the methods may include an out-of-band monitoring device to sit passive on the network without modifying or altering any of the network traffic. Additionally, the proposed out-of-band monitoring device may be of type Switch Port Analyzer (SPAN) or a Test Access Point (TAP). Such a monitoring device may detect presence of communication between IP address of any of the network connected device and an IP address not assigned as the default gateway of the network connected device. Additionally, the monitoring device, as per the proposed systems and methods may analyze IP traffic source and destination port numbers to detect presence of unsolicited communication. The proposed systems and methods may also generate an administrative alert indicating presence of such communication. Further, the proposed systems and methods may identify the network connected device using the IP traffic attributes.

According to yet another aspect, the present disclosure relates to systems and methods of creating a network singularity for a network connected device deployed over a shared. VLAN. The proposed systems and the methods may include an out-of-band monitoring device to sit passive on the network without modifying or altering any of the network traffic. Additionally, the proposed out-of-band monitoring device may be of type Switch Port Analyzer (SPAN) or a Test Access Point (TAP). Such a monitoring device may track bidirectional connection state for all communication and detect presence of multitude of default gateway IP addresses within the network. The proposed systems and methods may generate an administrative alert indicating presence of such communication. Further, the proposed systems and methods may identify the default gateway using the IP traffic attributes.

According to yet another aspect, the present disclosure relates to systems and methods of creating a network singularity for a network connected device deployed over a shared VLAN. The proposed systems and the methods may include one or multitude of out-of-band monitoring devices and inline unsolicited communication detection methods whereby one or more of the proposed systems and methods are integrated within the network appliances such as switches, routers, wireless access points, or network security appliances.

### BRIEF DESCRIPTION OF THE DRAWINGS

The present disclosure is illustrated and described herein with reference to the various drawings, in which like reference numbers are used to denote like system components/method steps, as appropriate in which:

FIG. 1 illustrates a shared network topology, according to at least one aspect of the present disclosure.

FIG. 2 illustrates a shared network topology with network singularities, according to at least one aspect of the present disclosure.

FIG. 3 illustrates logical functions of a network singularity system, according to at least one aspect of the present disclosure.

FIG. 4 illustrates a flowchart for unauthorized communication detection process, according to at least one aspect of the present disclosure.

FIG. 5 illustrates a flowchart for actions on receiving unsolicited response, according to at least one aspect of the present disclosure.

FIG. 6 illustrates a flowchart for recording device attributes, according to at least one aspect of the present disclosure.

FIG. 7 illustrates flowchart for actions on detecting packets to or from unauthorized gateways, according to at least one aspect of the present disclosure.

FIG. 8 illustrates an example computer device suitable for use to practice aspects of the present disclosure.

FIG. 9 illustrates an example non-transitory computer-readable storage media having instructions configured to practice all or selected ones of the operations associated with aspects of the present disclosure.

### DETAILED DESCRIPTION OF THE DISCLOSURE

Reference will now be made in detail to embodiments, examples of which are illustrated in the accompanying drawings. In the following detailed description, numerous specific details are set forth in order to provide a thorough understanding of the present aspect. However, it will be apparent to one of ordinary skill in the art that the present aspect may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present aspect. The first contact and the second contact are both contacts, but they are not the same contact.

The terminology used in the description of the present aspect herein is for the purpose of describing particular embodiments only and is not intended to be limiting of the present disclosure. As used in the description of the present disclosure and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if (a stated condition or event) is detected” may be construed to mean “upon determining” or “in response to determining” or “upon detecting (the stated condition or event)” or “in response to detecting (the stated condition or event),” depending on the context.

The foregoing description, for purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the present disclosure and its practical applications, to thereby enable others skilled in the art to best utilize various aspects of the present disclosure and various embodiments with various modifications as are suited to the particular use contemplated. The present disclosure should therefore not be limited by the above described embodiment, method, and examples, but by all embodiments and methods within the scope of the present disclosure and appended claims.

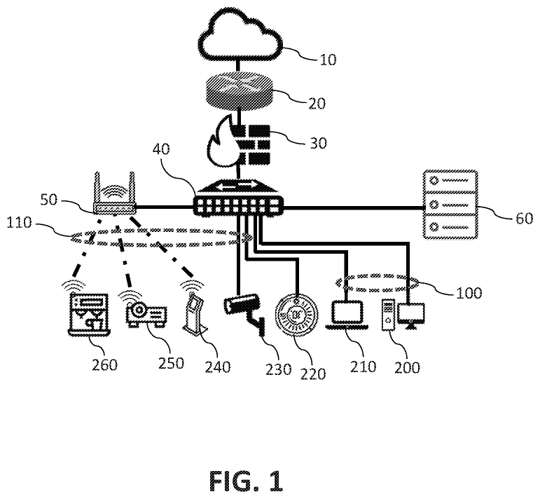

FIG. 1 illustrates a shared network topology for network connected devices, according to at least one aspect of the present disclosure. As illustrated, a desktop computer 200, a laptop computer 210, a thermostat 220, and a surveillance camera 230 may be connected to the network via switch 40 using a wired network connection. In one aspect, the switch 40 may be an Ethernet switch. A kiosk 240, a projector 250, and a coffee machine 260 may be connected to the network via a wireless access point 50 using a wireless WiFi network connection. The access point 50 may be connected to the network via a switch 40 using a wired network connection. The switch 40 also may connect with a firewall 30. The firewall 30 may connect with a router 20 which may connect to the internet 10. A Dynamic Host Configuration Protocol (DHCP) server 60 may connect to the network via a switch 40.

Further, as illustrated in FIG. 1, the desktop computer 200 and the laptop computer 210 may be connected to the network using a shared VLAN-1 100. Similarly, a thermostat 220, a surveillance camera 230, a kiosk 240, a projector 250, and a coffee machine 260 may be connected to the network using another shared VLAN-2 110.

In further detail, still referring to FIG. 1, various functions such as the DHCP server 60, the router 20, the firewall 30, and the switch 40 may be integrated inside one or more physical or virtual appliances. The DHCP server 60 may provide IP address assignment and management functions. One or more of DHCP servers 60, Ethernet switches 40, routers 20, wireless access points 50, and firewalls 30 may be instantiated for effective network operation. Further, the connectivity topology may be reorganized to achieve similar functionality.

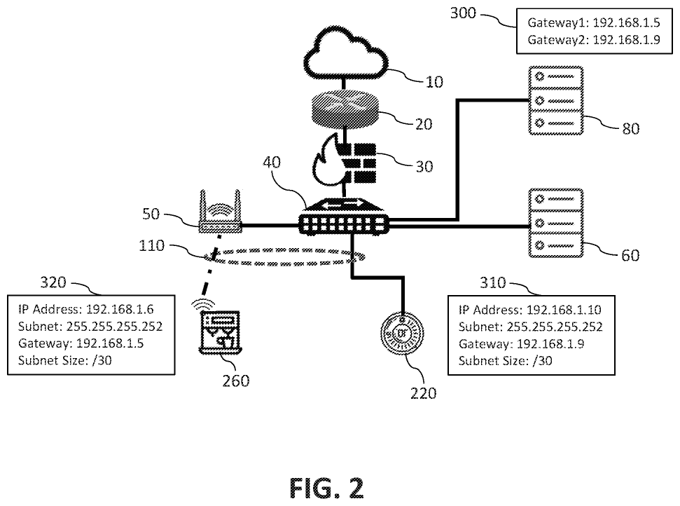

FIG. 2 illustrates shared network topology with network singularities, according to at least one aspect of the present disclosure. As illustrated in FIG. 2, a thermostat 220 and a coffee machine 260 may be connected to the network using a shared VLAN-2 110. A network singularity system 80 may be connected to the network via a switch 40. The network singularity system 80 also may be connected to the DHCP server 60 using APIs.

In further detail, still referring to FIG. 2, the network singularity system 80 may request the DHCP server 60 to allocate 192.168.1.10/30 IP address subnet for the thermostat 220. The subnet details 310 illustrates various subnet parameters for the thermostat 220. The network singularity system 80 also may instantiate a default gateway2 with IP address 192.168.1.9 as illustrated in a default gateway table 300. As per the exemplary aspect, the 192.168.1.10/30 subnet along with IP address schema and the associated gateway2 form a network singularity.

Similarly, in further detail, still referring to FIG. 2, the network singularity system 80 may request the DHCP server 60 to allocate 192.168.1.6/30 IP address subnet for the coffee machine 260. The subnet details 320 illustrates various subnet parameters for the coffee machine 260. The network singularity system 80 also may instantiate a default gateway1 with IP address 192.168.1.5 as illustrated in the default gateway table 300. As per the exemplary aspect, the 192.168.1.6/30 subnet along with IP address schema and the associated gateway1 form another network singularity.

FIG. 2 illustrates an example of a slash thirty (/30) subnet being allocated for the network singularity system 80. Similar results may be achieved by creating a slash twenty four (/24) subnet or a slash sixteen (/16) or a network of varying sizes. The subnet and the IP addresses for the default gateway and the network connected device may be created such that there may be only one network connected device or a group of network connected devices authorized to allow direct communication in between the group of devices. As illustrated in FIG. 2, there is one default gateway assigned for each of the subnets. Instead of allocating a DHCP IP address, the network singularity system 80 also may assign fixed IP addresses to the coffee machine 260 and the thermostat 220. The network singularity system 80 also may be integrated with other functions such as the DHCP server 60, the router 20, the firewall 30, and the switch 40 built using one or more physical or virtual appliances. Over a shared network, more than one network singularity systems 80 may be instantiated for effective operation. Further, the connectivity topology may be reorganized. For example, some of the illustrated functions may be connected directly to the router 20 or instantiated in a remote location such as a public cloud. Further, IP packet tunnels may be established to provide network connectivity between local and remote functions. Further, such IP packet tunnels may use cryptography to encrypt and decrypt the traffic.

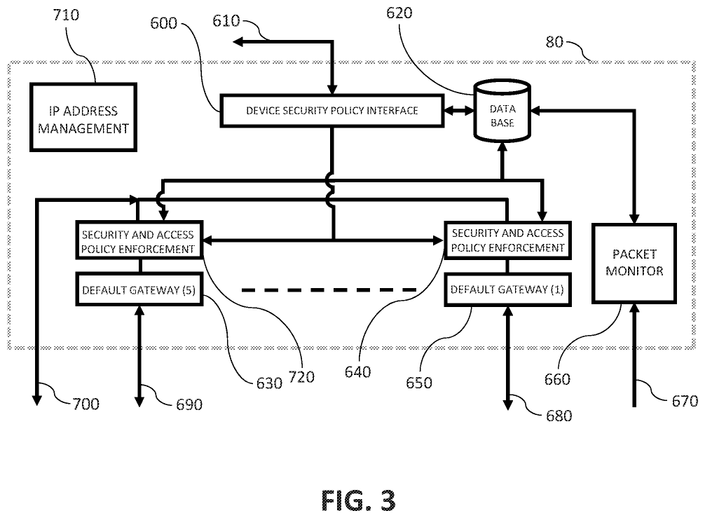

FIG. 3 illustrates logical functions of a network singularity system 80, according to at least one aspect of the present disclosure. As illustrated, a Default Gateway (1) 650 may be instantiated for the first network connected device. The Default Gateway (1) 650 may logically connect to the network via network connection 680. Similarly, the Default Gateway (5) 630 may be instantiated for a fifth network connected device. The Default Gateway (5) 630 may logically connect to the network via a network connection 690. Plurality of default gateways may be instantiated for respective network connected devices to create multitude of network singularities.

In further detail, still referring to FIG. 3, security and access policy management functions may be instantiated for respective default gateways and the said function may be responsible for enforcing security and access policies for respective network singularities. As illustrated, a Security and Access Policy Management 640 function associated with the Default Gateway (1) 650 may be instantiated and a Security and Access Policy Management 720 function associated with Default Gateway (5) 630 may be instantiated. The Security and Access Policy Management 640 function may be responsible for policy enforcement for the network singularity associated with the Default Gateway (1) 650. Similarly, the Security and Access Policy Management 720 function may be responsible for policy enforcement for the network singularity associated with the Default Gateway (5) 630. After the security and access policy enforcement function gets executed, the packets from the network connected device may be sent back to the network via the network interface 700. Similarly, packets destined for the network connected device received via the network interface 700 may go through respective security and access policy enforcement function. Further, the packets may be sent to the network connected device via the associated default gateway.

In further detail, still referring to FIG. 3, the Security and Access Policy Management 640 function may consult with the security policy database 620 via the Device Security Policy Interface 600. Similarly, the Security and Access Policy Management 720 function may consult with security policy database 620 via the Device Security Policy Interface 600. The Device Security Policy Interface 600 also may publish APIs to update network singularity specific security policies that may be stored in the security policy database 620.

As illustrated in FIG. 3, a Packet Monitor 660 function may logically connect to the shared network via the network interface 670. The Packet Monitor 660 function may monitor traffic on the network to detect unauthorized communication from network connected devices. Further, the Packet Monitor 660 function may detect unsolicited responses from the network connected devices deployed over the shared network. The Packet Monitor 660 function may consult with the security policy database 620 and update the stored information upon detecting unauthorized communication and/or witnessing unsolicited responses from the network.

The IP Address Management 710 system illustrated in FIG. 3 may manage the IP address allocations in concert with a DHCP server. The IP Address Management 710 system may pre-create subnets such that the DCHP server may allocate unique subnets for the connecting devices, or the IP Address Management 710 system may create new and unique subnet on connection request from the network connected devices. Further, the IP Address Management 710 system may assign fixed IP address for the network connected device and the associated default gateway. In addition, if the network connected devices stay inactive for a certain period of time, the IP Address Management 710 system may suspend the associated subnet, IP addresses, the default gateway, and the associated security and access policy enforcement functions. Such a discarded subnet may be recreated on subsequent network connected device's connection request. System transactions may be recorded in a database for troubleshooting and/or compliance purposes.

In further detail, still referring to FIG. 3, various functionalities such as security policy database, packet monitoring, device security policy interface, default gateways, IP address management system, and security and access policy enforcement functions may be integrated in one or multiple functions.

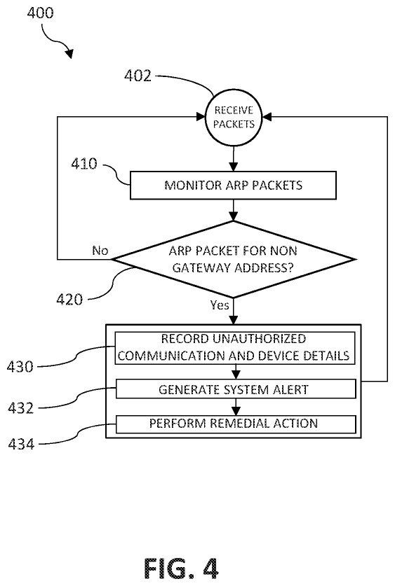

FIG. 4 illustrates a flowchart 400 describing an exemplary operation of a network singularity system's 80 unauthorized communication detection process, according to at least one aspect of the present disclosure. Incoming packets on the VLAN-2 110 may be received 402 by a Packet Monitor 660. From the stream of incoming packets, the ARP packets may be monitored 410 for further inspection. The contents of the ARP packets may be scanned for ARP request from network connected device to an IP address other than the default gateway associated with the connected device to detect 420 whether an ARP packet is destined for an address that is not a gateway assigned to the device sending the ARP packet. An ARP request for an IP address except for the associated gateway address of the network singularity may indicate presence of unauthorized communication. If no unauthorized communication is detected 420, the network singularity system 80 may continue to monitor 420 incoming packets. Upon detection 420 of unauthorized communication, the network singularity system 80 may record 430 the unauthorized communication and store it in a database. Further, the network singularity system 80 may record 430 details of device involved in the unauthorized communication. Additionally, the network singularity system 80 may generate 432 a system alert for notification and remedial action purposes. Further, the network singularity system 80 may perform 434 remedial action and continue to receive 402 and monitor 410 the incoming packet stream.

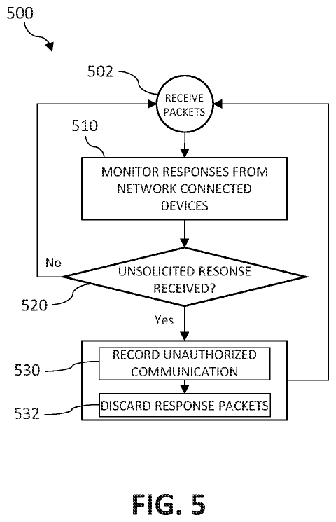

FIG. 5 illustrates a flowchart 500 describing an exemplary operation of a network singularity system's 80 actions on receiving unsolicited response packets, according to at least one aspect of the present disclosure. Incoming packets on VLAN-2 110 may be received 502 by the Packet Monitor 660. The contents of the incoming packet stream may be monitored 510 for network connected device's response to external requests. An unsolicited response from the network connected device detected 520 in response to a request not previously seen by the network singularity system's gateway may indicate the presence of unauthorized communication. If no unauthorized communication is detected 520, the network singularity system 80 may continue to monitor 502 incoming packets. Upon detection 520 of unauthorized communication, the network singularity system 80 may record 530 the unauthorized communication and discard 532 response packets. Further, the network singularity system 80 may perform 534 remedial action and continue to receive 502 and monitor 510 the incoming packet stream.

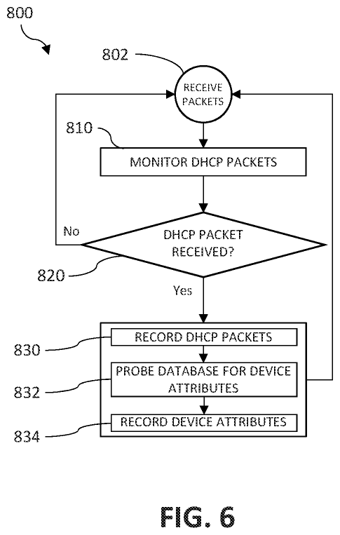

FIG. 6 illustrates flowchart 800 describing an exemplary operation of a network singularity system's 80 process of recording device attributes, according to at least one aspect of the present disclosure. Incoming packets on VLAN-2 110 may be received 802 by the Packet Monitor 660. The contents of the incoming packet stream may be monitored 810 for DHCP packets. Upon receipt 820 of the DHCP packets, the network singularity system 80 may record the contents of the DHCP packets. Further, the network singularity system 80 may probe multiple databases using the content of the DHCP packets in order to gather attributes of the network connected device. Additionally, the gathered attributes may be recorded in a database. The network singularity system 80 may continue to receive 802 and monitor packet stream. If the DHCP packets are not received 820, the network singularity system 80 may continue to receive 802 and monitor 810 incoming packet stream.

Further, the network singularity system 80 may probe multiple databases using the contents of the DHCP packets in order to gather attributes of the network connected device. Additionally, the gathered attributes may be recorded in a database. The network singularity system 80 may continue to receive 802 and monitor 810 the packet stream. If the DHCP packets are not received 820, the network singularity system 80 may continue to receive 802 and monitor 810 the incoming packet stream.

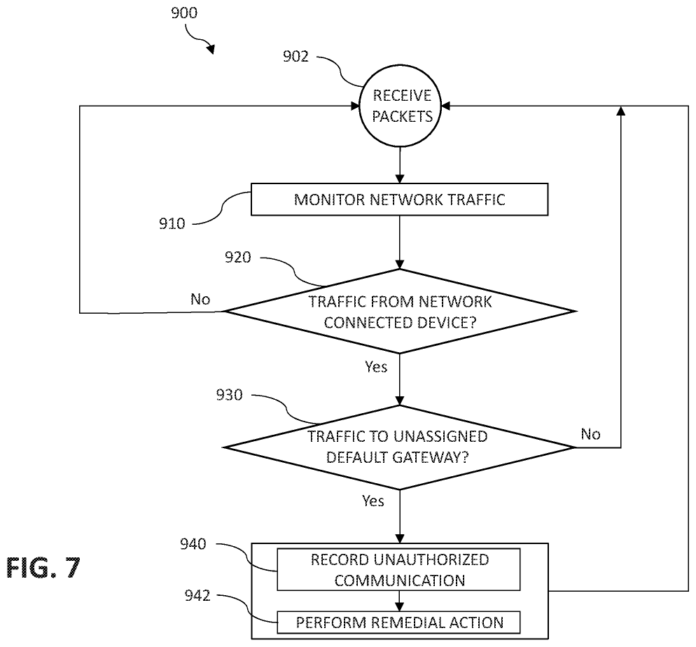

FIG. 7 illustrates a flowchart 900 describing an exemplary operation of a network singularity system's 80 process of actions on detecting packets to or from unauthorized gateways, according to at least one aspect of the present disclosure. Incoming packets on VLAN-2 110 may be received 992 by the Packet Monitor 660. The contents of the incoming packet stream may be monitored 910 for traffic from the network connected devices. Upon receipt 992 of the packets from the network connected device, the network singularity system 80 may detect 930 if the traffic is destined to a destination IP address other than that of the default gateway assigned to the network connected device. Such traffic may be labeled as unauthorized communication. If no unauthorized communication is detected 930, the network singularity system 80 may continue to monitor 902 incoming packets. Upon detection 930 of unauthorized communication, the network singularity system 80 may record 940 the unauthorized communication. Further, the network singularity system 80 may perform 942 remedial action and continue to receive 902 and monitor 910 incoming packet stream.

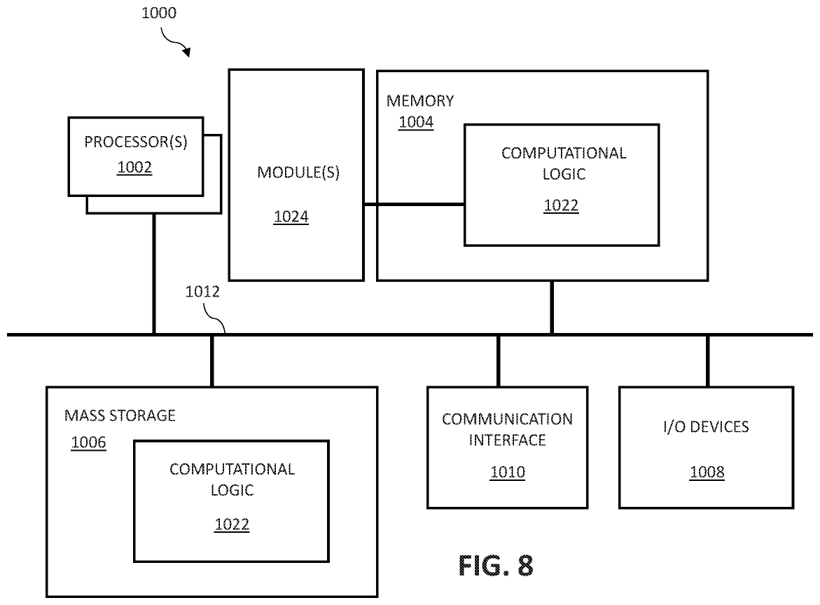

FIG. 8 illustrates an example computer device 1000 suitable for use to practice aspects of the present disclosure. In some aspects, the computer device 1000 may comprise at least a portion of any of the router 20, firewall 30, switch 40, access point 50, DHCP server 60, or network singularity system 80. As shown, the computer device 1000 may include one or more processors 1002, and system memory 1004. The processor 1002 may include any type of processors. The processor 1002 may be implemented as an integrated circuit having a single core or multi-cores, e.g., a multi-core microprocessor. The computer device 1000 may include mass storage devices 1006 (such as diskette, hard drive, volatile memory (e.g., DRAM), compact disc read only memory (CD-ROM), digital versatile disk (DVD), flash memory, solid state memory, and so forth). In general, system memory 1004 and/or mass storage devices 1006 may be temporal and/or persistent storage of any type, including, but not limited to, volatile and non-volatile memory, optical, magnetic, and/or solid state mass storage, and so forth. Volatile memory may include, but not be limited to, static and/or dynamic random access memory. Non-volatile memory may include, but not be limited to, electrically erasable programmable read only memory, phase change memory, resistive memory, and so forth.

The computer device 1000 may further include input/output (I/O) devices 1008 such as a microphone, sensors, display, keyboard, cursor control, remote control, gaming controller, image capture device, and so forth and communication interfaces 1010 (such as network interface cards, modems, infrared receivers, radio receivers (e.g., Bluetooth)), antennas, and so forth.

The communication interfaces 1010 may include communication chips (not shown) that may be configured to operate the computer device 1000 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as an other wireless protocols that are designated as 3G, 4G, 5G, and beyond. The communication interfaces 1010 may operate in accordance with other wireless protocols in other embodiments.

The above-described computer device 1000 elements may be coupled to each other via a system bus 1012, which may represent one or more buses. In the case of multiple buses, they may be bridged by one or more bus bridges (not shown). Each of these elements may perform its conventional functions known in the art. In particular, the system memory 1004 and the mass storage devices 1006 may be employed to store a working copy and a permanent copy of the programming instructions implementing the operations associated with the network topologies and processes described in reference to FIGS. 1-7, e.g., operations associated with providing one or more of modules 1024 as described above in reference to FIGS. 4-7, generally shown as computational logic 1022. The computational logic 1022 may be implemented by assembler instructions supported by the processor(s) 1002 or high-level languages that may be compiled into such instructions. The permanent copy of the programming instructions may be placed into the mass storage devices 1006 in the factory, or in the field, through, for example, a distribution medium (not shown), such as a compact disc (CD), or through the communication interfaces 1010 (from a distribution server (not shown)).

In various aspects, one or more of the modules 1024 may be implemented in hardware integrated with, e.g., communication interface 1010. In other aspects, one or more of the modules 1024 (or some functions of the modules 1024) may be implemented in a hardware accelerator integrated with, e.g., the processor 1002, to accompany the central processing units (CPU) of the processor 1002 to execute the processes 400, 500, 800, 900 described herein in reference to FIGS. 4-7.

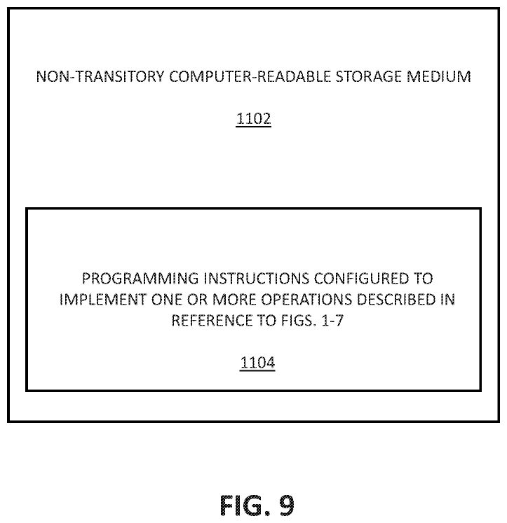

FIG. 9 illustrates an example non-transitory computer-readable storage media 1102 having instructions configured to practice all or selected ones of the operations associated with the processes described above. As illustrated, the non-transitory computer-readable storage medium 1102 may include a number of programming instructions 1104 configured to implement one or more of the modules 1024, or the processes 400, 500, 800, 900 described herein in reference to FIGS. 4-7. The programming instructions 1104 may be configured to enable a device, e.g., the computer device 1000, in response to execution of the programming instructions, to perform one or more operations of the processes described in reference to FIGS. 1-7. In alternate aspects, programming instructions 1104 may be disposed on multiple non-transitory computer-readable storage media 1102 instead. In still other aspects, the programming instructions 1104 may be encoded in transitory computer-readable signals.

Referring again to FIG. 8, the number, capability, and/or capacity of the elements 1008, 1010, 1012 may vary, depending on whether the computer device 1000 is used as a stationary computing device, such as a set-top box or desktop computer, or a mobile computing device, such as a tablet computing device, laptop computer, game console, an Internet of Things (IoT), or smartphone. Their constitutions are otherwise known, and accordingly will not be further described.

At least one of the processors 1002 may be packaged together with memory having the computational logic 1022 (or portion thereof) configured to practice aspects of embodiments described in reference to FIGS. 1-7. For example, the computational logic 1022 may be configured to include or access one or more of the modules 1024. In some aspects, at least one of the processors 1002 (or portion thereof) may be packaged together with memory having computational logic 1022 configured to practice aspects of the processes 400, 500, 800, 900 in reference to FIGS. 4-7 to form a System in Package (SiP) or a System on Chip (SoC).

In various implementations, the computer device 1000 may comprise a desktop computer, a server, a router, a switch, or a gateway. In further implementations, the computer device 1000 may be any other electronic device that processes data.

Although certain aspects have been illustrated and described herein for purposes of description, a wide variety of alternate and/or equivalent aspects or implementations calculated to achieve the same purposes may be substituted for the aspects shown and described without departing from the scope of the present disclosure. This application is intended to cover any adaptations or variations of the embodiments discussed herein.

Examples of the methods and/or systems of various aspects of the present disclosure are provided below. An aspect of the methods and/or systems may include any one or more than one, and any combination of, the examples described below.

Example 1 is a method including: creating a network singularity for a network connected device over a shared network; and analyzing network traffic across the shared network to detect unauthorized communication from the network connected device.

Example 2 may include the subject matter of Example 1, and further may include detecting an unsolicited response from the network connected device; and discarding unsolicited response packets.

Example 3 may include the subject matter of any one or more of Examples 1-2, and further may include detecting the unsolicited response from the network connected device via passively monitoring network traffic.

Example 4 may include the subject matter of any one or more of Examples 1-3, and further may include generating system alert events; and recording the system alert events in a database.

Example 5 may include the subject matter of any one or more of Examples 1-4, and further may include taking remedial action for the network connected device; and restricting network access for the network singularity.

Example 6 may include the subject matter of any one or more of Examples 1-5, and further may include leveraging traffic details to access a device information database; and updating device attributes in the device information database.

Example 7 may include the subject matter of any one or more of Examples 1-6, and further may include providing security and access control for the network singularity.

Example 8 may include the subject matter of any one or more of Examples 1-7, and further may include creating a network subnet, the network subnet including: a default gateway internet protocol (IP) address; and a network connected device IP address; instantiating the default gateway for the network singularity; and recording and managing IP addresses for the network singularity.

Example 9 may include the subject matter of any one or more of Examples 1-8, and further may include instantiating the default gateway for the network singularity at a remote location; and providing network connectivity to the default gateway via protocol tunneling.

Example 10 may include the subject matter of any one or more of Examples 1-9, and further may include detecting inactivity of the network connected device for a predetermined period of time; deconstructing an associated configuration of the default gateway; and deconstructing an associated subnet.

Example 11 may include the subject matter of any one or more of Examples 1-10, and further may include providing centralized security policy database hosting security and access control policies for the network singularity, the centralized security policy database further comprising an application programming interface for policy updates; updating policies using application programming interface; and enforcing security policies for the network singularity.

Example 12 may include the subject matter of any one or more of Examples 1-11, where the application programming interface further may include recording transactions using blockchain proof-of-work based methods.

Example 13 is a method including: creating a network singularity for a network connected device over a shared network; analyzing network traffic across the shared network to detect unauthorized communication from the network connected devices; detecting unsolicited response from the network connected device; discarding unsolicited response packets; detecting the unsolicited response from the network connected device via passively monitoring network traffic; generating a system alert event; recording the system alert event in a database; taking remedial action for the network connected device; restricting network access for the network singularity; leveraging traffic details to access a device information database; updating device attributes in the device information database; security and access control for the network singularity; creating a network subnet that further may include: a default gateway internet protocol (IP) address; and a network connected device IP address; instantiating the default gateway for the network singularity; recording and managing IP addresses for the network singularity; instantiating the default gateway for the network singularity at a remote location; providing network connectivity to the default gateway via protocol tunneling; detecting inactivity of the network connected device for a predetermined period of time; deconstructing an associated configuration of the default gateway; deconstructing an associated subnet; enforcing security policies for the network singularity; providing centralized security policy database hosting security and access control policies for the network singularity, the centralized security policy database further comprising an application programming interface for policy updates; updating policies using application programming interface; and recording transactions by using blockchain proof-of-work based methods.

Example 14 is a network singularity system for a network connected device over a shared network, the network singularity system including: a processor coupled to a memory, the processor configured to execute a plurality of instructions, wherein when executed by the processor cause the network singularity system to: analyze network traffic of the shared network to detect unauthorized communication from the network connected device; and generate an internet protocol (IP) subnet for the network singularity.

Example 15 may include the subject matter of Example 14, and further may include a plurality of instructions executed by the processor to cause the network singularity system to: detect an unsolicited response from the network connected device; and discard unsolicited response packets.

Example 16 may include the subject matter of any one or more of Examples 14-15, and further may include a plurality of instructions executed by the processor cause the network singularity system to: passively monitor the network traffic; and detect unsolicited response from the network connected device via passively monitored network traffic.

Example 17 may include the subject matter of any one or more of Examples 14-16, and further may include a plurality of instructions executed by the processor cause the network singularity system to: generate system alert events; and record the system alert events in a database.

Example 18 may include the subject matter of any one or more of Examples 14-17, and further may include a plurality of instructions executed by the processor cause the network singularity system to: take remedial action for the network connected device; and restrict network access for the network singularity.

Example 19 may include the subject matter of any one or more of Examples 14-18, and further may include a plurality of instructions executed by the processor cause the network singularity system to: leverage traffic details to access a device information database; and update device attributes in the device information database.

Example 20 may include the subject matter of any one or more of Examples 14-19, and further may include a security and access control system for the network singularity.

Example 21 may include the subject matter of any one or more of Examples 14-20, and further may include a plurality of instructions executed by the processor cause the network singularity system to: create a network subnet where the subnet further may include: a default gateway IP address; and a network connected device IP address; instantiate the default gateway for the network singularity; and record and manage IP addresses for network singularity.

Example 22 may include the subject matter of any one or more of Examples 14-21, and further may include a plurality of instructions executed by the processor cause the network singularity system to: instantiate the default gateway for the network singularity at a remote location; and a system for providing network connectivity to the default gateway via protocol tunneling.

Example 23 may include the subject matter of any one or more of Examples 14-22, and further may include a plurality of instructions executed by the processor cause the network singularity system to: detect the network connected device's inactivity for a certain period of time; deconstruct associated default gateway configuration; and deconstruct associated subnet.

Example 24 may include the subject matter of any one or more of Examples 14-23, and further may include a centralized security policy database system to host security and access control policies for the network singularity, the centralized security policy database system further may include: an application programming interface for the security policy updates; and a security policy enforcer for the network singularity.

Example 25 may include the subject matter of any one or more of Examples 14-24, and further may include: a plurality of instructions executed by the processor cause the network singularity system to record transactions using blockchain proof-of-work based systems.

Example 26 is a network singularity system for a network connected device over a shared network, the network singularity system including: a processor coupled to a memory, the processor configured to execute a plurality of instructions, wherein when executed by the processor cause the network singularity system to: analyze network traffic of the shared network to detect unauthorized communication from the network connected device; generate an internet protocol (IP) subnet for the network singularity; detect an unsolicited response from the network connected device; discard unsolicited response packets; passively monitor the network traffic; detect unsolicited response from the network connected device via passively monitored network traffic: generate system alert events; record the system alert events in a database; take remedial action for the network connected device; restrict network access for the network singularity; leverage traffic details to access a device information database; update device attributes in the device information database; create a network subnet wherein the subnet further may include: a default gateway IP address; and a network connected device IP address; instantiate the default gateway for the network singularity; record and manage IP addresses for network singularity; instantiate the default gateway for the network singularity at a remote location; a system for providing network connectivity to the default gateway via protocol tunneling; detect the network connected device's inactivity for a certain period of time; deconstruct associated default gateway configuration; and deconstruct associated subnet.

Example 27 may include the subject matter of Examples 26, and further may include a security and access control system for the network singularity.

Example 28 may include the subject matter of any one or more of Examples 26-27, and further may include: a centralized security policy database system to host security and access control policies for the network singularity, the centralized security policy database system further may include: an application programming interface for the security policy updates; and a security policy enforcer for the network singularity.

Example 29 may include the subject matter of any one or more of Examples 26-28, and further may include a plurality of instructions executed by the processor cause the network singularity system to record transactions using blockchain proof-of-work based systems.

Although certain aspects of the foregoing description, for purpose of explanation, have been described with reference to specific aspects, the illustrative discussions above are not intended to be exhaustive or to limit the various aspects of the present disclosure to the precise forms disclosed. Many modifications and variations are possible in view of the above teachings. The disclosed aspects were chosen and described in order to best explain the principles of the present disclosure and its practical applications, to thereby enable others skilled in the art to best utilize the various aspects of the present disclosure with various modifications as are suited to the particular use contemplated. Accordingly, a wide variety of alternate and/or equivalent aspects or implementations calculated to achieve the same purposes may be substituted for the aspects shown and described without departing from the scope of the present disclosure. This application is intended to cover any adaptations or variations of the aspects discussed herein.

What is claimed is:

1. A method comprising:
creating a network singularity for a network connected device connected to a network using a shared network, wherein creating the network singularity comprises:
assigning a network subnet for the network connected device;
assigning a default gateway for the network subnet, wherein the network subnet comprises:
a default gateway internet protocol (IP) address for the default gateway; and
a network connected device IP address for the network connected device;
instantiating the default gateway for the network singularity;
recording and managing IP addresses for the network singularity;
analyzing network traffic across the shared network; and
detecting unauthorized communication from the network connected device, if network traffic from the network connected device is destined to a destination IP address other than the IP address of the default gateway.

2. The method of claim 1, further comprising:
detecting an unsolicited response from the network connected device via passively monitoring network traffic, wherein the unsolicited response results from an unauthorized request to the network singularity.

3. The method of any one or more of claims 1 through 2, further comprising:
generating system alert events; and
recording the system alert events in a database.

4. The method of any one or more of claims 1 through 3, further comprising:
taking remedial action for the network connected device.

5. The method of any one or more of claims 1 through 4, further comprising:
leveraging traffic details to access a device information database; and
updating device attributes in the device information database.

6. The method of any one or more of claims 1 through 5, further comprising:
providing security and access control for the network singularity.

7. The method of claim 1, further comprising:
instantiating the default gateway for the network singularity at a remote location; and
providing network connectivity to the default gateway via protocol tunneling.

8. The method of claim 1, further comprising:
detecting inactivity of the network connected device for a predetermined period of time;
deconstructing an associated configuration of the default gateway; and
deconstructing an associated subnet.

9. The method of any or more of claims 1 through 8, further comprising:
providing centralized security policy database hosting security and access control policies for the network singularity, the centralized security policy database further comprising an application programming interface for policy updates;
updating policies using application programming interface; and
enforcing security policies for the network singularity.

10. The method of claim 9, wherein the application programming interface further comprises recording transactions using blockchain proof-of-work based methods.

11. A network singularity system for a network connected device over a shared network, the network singularity system comprising:
a processor coupled to a memory, the processor configured to execute a plurality of instructions, wherein when executed by the processor cause the network singularity system to:
assign a network singularity for a network connected device connected to a network using a shared network, wherein creating the network singularity comprises:
create a network subnet for the network connected device;
assign a default gateway for the network subnet, wherein the network subnet comprises:
a default gateway internet protocol (IP) address for the default gateway; and
a network connected device IP address for the network connected device;
instantiate the default gateway for the network singularity;
record and manage IP addresses for the network singularity;
analyze network traffic of the shared network; and
detect unauthorized communication from the network connected device, if network traffic from the network connected device is destined to a destination IP address other than the IP address of the default gateway.

12. The network singularity system of claim 11, wherein the plurality of instructions executed by the processor cause the network singularity system to:
passively monitor the network traffic; and
detect an unsolicited response from the network connected device via passively monitored network traffic, wherein the unsolicited response results from an unauthorized request to the network singularity.

13. The network singularity system of any one or more of claims 11 through 12, wherein the plurality of instructions executed by the processor cause the network singularity system to:
generate system alert events; and
record the system alert events in a database.

14. The network singularity system of any one or more of claims 11 through 13, wherein the plurality of instructions executed by the processor cause the network singularity system to:
take remedial action for the network connected device.

15. The network singularity system of any one or more of claims 11 through 14, wherein the plurality of instructions executed by the processor cause the network singularity system to:
leverage traffic details to access a device information database; and
update device attributes in the device information database.

16. The network singularity system of any one or more of claims 11 through 15, further comprising provide a security and access control for the network singularity.

17. The network singularity system of claim 11, wherein the plurality of instructions executed by the processor cause the network singularity system to:
instantiate the default gateway for the network singularity at a remote location; and
a system for providing network connectivity to the default gateway via protocol tunneling.

18. The network singularity system of claim 11, wherein the plurality of instructions executed by the processor cause the network singularity system to:
detect the network connected device's inactivity for a certain period of time;
deconstruct associated default gateway configuration; and
deconstruct associated subnet.

19. The network singularity system of any one or more of claims 11 through 18, further comprising:
a centralized security policy database system to host security and access control policies for the network singularity, the centralized security policy database system further comprising:
an application programming interface to update the security policy; and
a security policy enforcer to enforce security policies for the network singularity.

20. The network singularity system of claim 19, wherein the plurality of instructions executed by the processor cause the network singularity system to:
record transactions using blockchain proof-of-work based systems.

21. A method comprising:
creating a network singularity for a network connected device connected to a network using a shared network, wherein creating the network singularity comprises:
assigning a network subnet for the network connected device;
assigning a default gateway for the network subnet, wherein the network subnet comprises:
a default gateway internet protocol (IP) address for the default gateway; and
a network connected device IP address for the network connected device;
instantiating the default gateway for the network singularity;
recording and managing IP addresses for the network singularity;
analyzing network traffic across the shared network;
detecting an unsolicited response from the network connected device; and
discarding unsolicited response packets.

22. A network singularity system for a network connected device over a shared network, the network singularity system comprising:
a processor coupled to a memory, the processor configured to execute a plurality of instructions, wherein when executed by the processor cause the network singularity system to:
assign a network singularity for a network connected device connected to a network using a shared network, wherein creating the network singularity comprises:
create a network subnet for the network connected device;
assign a default gateway for the network subnet, wherein the network subnet comprises:
a default gateway internet protocol (IP) address for the default gateway; and
a network connected device IP address for the network connected device;
instantiate the default gateway for the network singularity;
record and manage IP addresses for the network singularity;
analyze network traffic of the shared network;
detect an unsolicited response from the network connected device; and
discard unsolicited response packets.
